(19) United States
(12) Patent Application Publication
(10) Pub. No.: US 2010/0071072 A1
(43) Pub. Date: Mar. 18, 2010

(54) SYSTEM AND METHOD FOR CONTROLLING ACCESS TO LICENSE PROTECTED ASSETS USING USING RFID TECHNOLOGY

(75) Inventors: Josh Holland, Cedar Rapids, IA (US); James Seely, Cedar Rapids, IA (US); Dennis Born, Cedar Rapids, IA (US); Phyllis Tuner-Brim, Snohomish, WA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: INTERMEC IP CORP., Everett, WA (US)

(21) Appl. No.: 12/447,411

(22) PCT Filed: Oct. 26, 2007
(86) PCT No.: PCT/US2007/022758

§ 371 Date: Apr. 27, 2009

Related U.S. Application Data
(60) Provisional application No. 60/854,834, filed on Oct. 26, 2006.

(51) Int. Cl. G05B 19/00; G06F 21/00

(52) U.S. Cl. 726/27; 340/5.74

(57) ABSTRACT

Access to a license protected asset is limited by storing license information associated with the asset on at least one radio frequency identification (RFID) tag. Access to the asset is allowed only upon successful retrieval and verification of the license information by a device having at least one RFID reader.

### BACKGROUND

The present invention relates to the use of radio frequency identification tags in conjunction with license or copyright protected material.

When a consumer purchases a product, such as computer software or digital music, movies or games, the consumer is seldom free to use that product in any manner that the consumer wishes. Limitations on the consumer's use of the product are often the result of a license agreement that accompanies the purchase or use of the product. In addition, copyright law may limit the rights of consumers in certain respects.

For the producers of these products, it is important to ensure that consumers are prevented from using the product in a manner that violates the relevant license agreement or copyright law. Given the state of modern technology and the ease with which products, especially those in a digital form, can be copied, ensuring compliance with a license agreement or copyright law is not a simple task.

Previous solutions to this problem have often proved unsatisfactory. One solution to the problem of illegal or unauthorized copying of products, particularly software, is to require the user to manually enter a code at the time that the product is being installed. This method of ensuring compliance with a license or a copyright has proven easy to circumvent. Another common method of protecting software from illicit use is for the software's storage medium to contain a non-writeable region which is verified to ensure the validity of the copy. While this method is not easily circumvented, it is not practical in some situations. For example, this method is not practical in the case of operating systems, site licenses, or handheld devices which lack a reader for the original install medium.

The importance of ensuring compliance with license agreements and copyright law has grown considerably as entertainment industries, particularly the music and film industries, have embraced the distribution of their products in digital formats. The present invention provides a new way to ensure that the use of a product is in compliance with the terms of a license agreement and that it is not in violation of copyright law.

### SUMMARY

The present invention is a system and method for limiting access to a license protected asset by storing license information associated with the asset on at least one radio frequency identification (RFID) tag. Access to the asset is allowed only upon successful retrieval and verification of the license information by a device having at least one RFID reader.

### BRIEF DESCRIPTION OF THE DRAWINGS

FIG. 1 is a block diagram of a device equipped to implement a method of controlling access to a license protected asset.

FIG. 2 is a flow diagram showing the use of RFID technology to control access to a license protected asset.

FIG. 3 is a block diagram of a particular embodiment of a media player equipped to implement the method shown in FIG. 2.

### DETAILED DESCRIPTION

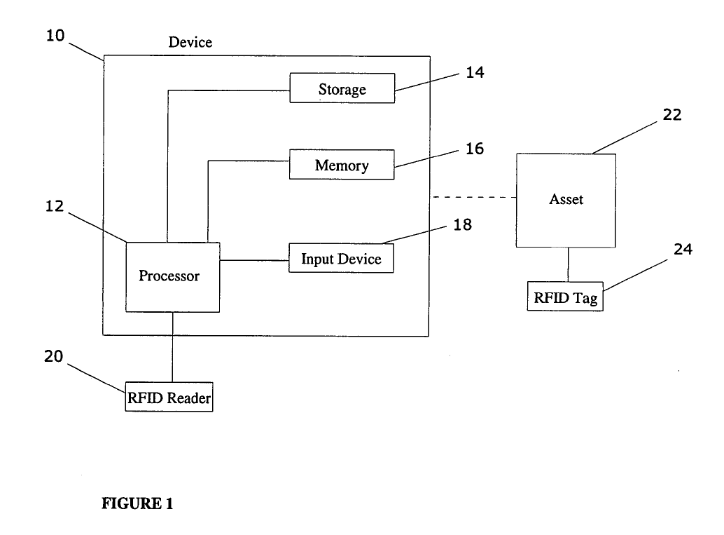

As an exemplary embodiment, FIG. 1 shows a block diagram of a device that implements the use of RFID technology to control access to a license protected asset.

In FIG. 1, a device 10 is shown. Device 10 is comprised of a processor 12, storage 14, memory 16, and an input device 18. Processor 12, storage 14, memory 16 and input device 18 are operatively connected as known to those skilled in the art of computer technology. Device 10 is representative of any device comprising these basic components such as a desktop computer or a hand-held computing device. Processor 12 operatively connects to RFID reader 20. In addition, FIG. 1 shows an asset 22. Asset 22 is any material such as software or digital media that can be accessed by device 10 and that can be protected by a license. Asset 22 is contained on a data storage medium in a format readable by input device 18. For example, asset 22 may be contained on a data storage medium such as a CD-ROM disk or a DVD disk which is physically present within input device 18 when access of asset 22 is attempted. Alternatively, asset 22 may be available in a downloadable form contained on a data storage medium separate from device 10 such as on a remote server. Of course, asset 22 can exist in any of a variety of other forms that are known to those skilled in the art of computer technology.

RFID tag 24 contains license information that is verified before device 10 is allowed access to asset 22. In an exemplary embodiment, RFID tag 24 is physically embedded or attached to the data storage medium containing asset 22. In another exemplary embodiment, RFID tag 24 is physically embedded or attached to a case that holds the data storage medium containing asset 22. In yet another exemplary embodiment, RFID tag 24 is located anywhere and in any form that allows RFID reader 20 to successfully read the information stored on RFID tag 24. This last embodiment is particularly useful in protecting an asset 22 when that asset is in a downloadable form as described above where asset 22 is located on a data storage medium that is distant from device 10. Additionally, although RFID tag 24 is described and illustrated as a single RFID tag, it should be understood that multiple tags may be employed, for purposes of redundancy or in order to store greater amounts of information in some embodiments.

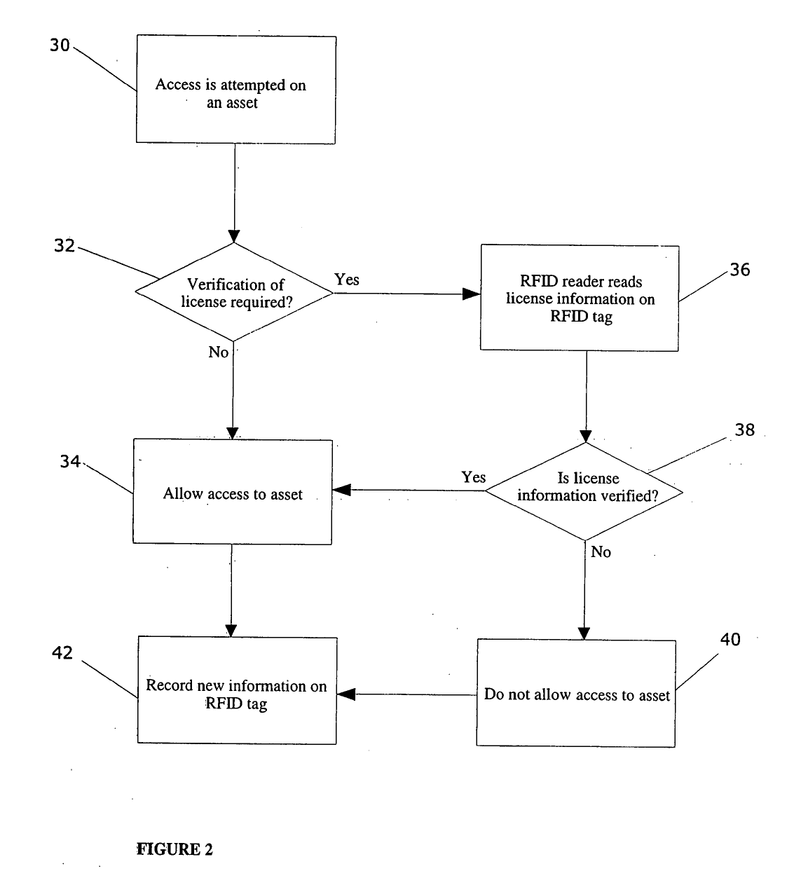

FIG. 2 is a flow diagram showing the use of RFID technology to control access to a license or copyright protected (or other rights-based protected) asset. First, a user attempts to access an asset as shown in step 30. Next, a determination is made whether the verification of license/rights information (hereafter referred to simply as license information) is required before allowing access as shown in step 32. If verification of license information is not required before allowing access, access is allowed without any further steps as shown in step 34. However, if during step 32, it is determined that verification of license information is required, a RFID reader reads license information contained on a RFID tag as shown in step 36. As shown in step 38, after the license information contained on the RFID tag is successfully read, the license information must be verified. For example, verification is accomplished by comparing the license information received by the RFID reader to stored verification information, such as information stored on the local hardware attempting access or on a remote server. If the license information is successfully verified, access is allowed to the asset as shown in step 34. However, if the license information is not successfully verified, access to the asset is not allowed as shown in step 40. In an exemplary embodiment, as shown in step 42, information may be recorded on the RFID tag following either the allowance or the denial of access to an asset.

Referring to step 32 of FIG. 2, whether verification of license information is required before granting access to a particular asset may depend on several factors. First, for example, verification of license information is not required when access to the asset is not restricted. Second, whether an asset's license information must be verified can depend on the nature of the access attempted in step 30. For example, in one scenario, the license information must be verified only when the user attempts to install an asset such as software or attempts to make a permanent copy of the asset. In another scenario, the license information must be verified anytime the user attempts to use the asset which is protected by the license information. As an example of this scenario, verification of the license information may be required anytime the user attempts to run previously installed software. As another example of this scenario, verification of the license information may be required anytime the user attempts to access an asset without making a permanent copy. For example, this scenario may be helpful when the asset is a digital movie or digital music.

Referring to step 38 of FIG. 2, the way in which access to an asset is limited during this verification step depends on the type of information which must be verified before allowing access to an asset. For example, the license information may comprise a simple authentication code much like a CD-key. In this case, the authentication code is verified by ensuring that the license information received by the RFID reader corresponds correctly to the asset. In another exemplary embodiment, the license information contains a start date or an expiration date. For example, verification of the license information fails if access is attempted before the start date or after the expiration date. Further embodiments include license verification based on limitations on the number of users that can access the asset, or limitations on users' abilities to read, copy, modify, write, or update the asset.

In other embodiments of the present invention, access to the asset is limited in part by new information recorded to the RFID tag, as shown in step 42 of FIG. 2. For example, the license information may contain the maximum number of times that access to the asset will be allowed, and the RFID tag may include a counter element. During step 42, each time the asset is accessed, information is recorded on the counter element of the RFID tag indicating that the asset had been accessed. In this embodiment, when the counter information on the RFID tag indicates that the maximum number of accesses has been reached, verification of the license information, shown in step 38, will fail. As described above, verification failure prevents access to the asset.

This exemplary embodiment is particularly useful for limiting access to software when one or more central servers are controlling software distribution. For example, in an office setting where individual computers install software from a central server, the RFID reader and the RFID tag are located with the server responsible for the distribution of the software. When an individual computer attempts to install software from the server, the method shown in FIG. 2 is performed before the server allows access to the software by the individual computer.

The information contained on the RFID tag can also be utilized to track many other use-limiting parameters to control access to the asset. In one exemplary embodiment, during step 42 shown in FIG. 2, information indicating the amount of time that the user has been employing the material contained on the asset is recorded on a recording element contained on the RFID tag. When the license information on the RFID tag indicates that a maximum amount of time has been reached, verification of the license information, shown in step 38, will fail and thus prevent access to the asset. This is useful when the license associated with the asset limits access based on the amount of time an asset, such as a software program, is actually in use.

Similarly, in another exemplary embodiment, the recording element contained on the RFID tag records the number of days from the first time that the asset was accessed. During verification step 38, if the license information on the RFID tag indicates that the maximum number of days has been reached, verification of the license information will fail and access to the asset will be denied. This is useful when the license associated with the asset limits access based on the number of days that an asset, such as a software program, is accessible to the user.

In another exemplary embodiment, during step 42 shown in FIG. 2, the RFID tag is recorded with information that identifies the particular hardware which has been granted access to asset. This information then becomes part of the information verified during step 38. One use for this information is to limit access to the asset to the particular hardware which originally accessed the asset.

In another exemplary embodiment, when access is denied because of one of the limiting variables discussed above, automatic notice to the licensor of the denial of access to the asset is provided. This notification allows the licensor the opportunity to renew or extend the license protecting the asset.

In another exemplary embodiment, the RFID tag includes other information that may or may not be directly related to the license and/or rights information on the tag. For example, the tag may indicate where the asset was purchased, or may include a URL that indicates where support, updated assets, or help information might be found.

Lastly, in another exemplary embodiment, the license information on the RFID tag may be erased, or the RFID tag may be completely inactivated, after access to the asset has been granted. These steps prevent subsequent access to the asset, and may be useful in scenarios where only a single access to an asset is desired, such as for demonstration, promotion, rental, or other highly restrictive applications.

It should be understood from the discussion above that a single RFID tag may be employed to provide license verification for multiple assets. For example, license information recorded on an RFID tag may allow a user to access all digital music or software downloaded from a particular service, or a certain number of digital music or software files downloaded from the service. That is, the downloaded music or software will only function if the appropriate license information is found on an RFID tag associated with the hardware that is attempting to access the music or software. Users then may have the ability to take their license rights with them by taking the RFID tag to whatever hardware they would like to use to access the asset. Other variations of the capabilities provided by the RFID-based license verification system described herein will be apparent to those skilled in the art.

As described above, this method ensures that access by a computer to a license or copyright protected asset, such as computer software, is in accordance with the terms of the asset's license or copyright.

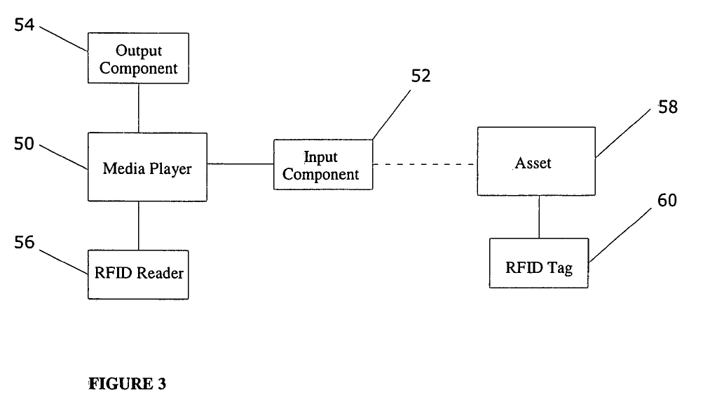

FIG. 3 shows a block diagram of a particular embodiment of a media playing system that implements the use of RFID technology to control access to an asset as shown by the flow chart in FIG. 2. Media player 50 has an input component 52 and an output component 54. Media player 50 operatively connects to a RFID reader 56. In addition, an asset 58 is shown. Asset 58 is any material playable by media player 50 such as digital movies or music. RFID tag 60 contains license information that is verified before media player 50 is allowed access to asset 58.

When the user of media player 50 wishes to play asset 58, media player 50 attempts to access asset 58 by reading asset 58 with input component 52. When access to asset 58 is attempted, a determination is made, typically by software associated with media player 50 in response to information such as digital rights management (DRM) information associated with asset 58, whether verification of license information is required before access is allowed to asset 58. If verification of license information is not required before allowing media player 50 to access asset 58, media player 50 is allowed access to asset 58. For example, this situation may arise when access to asset 58 is not protected by a license or copyright.

However, if verification of license information is required before allowing media player 50 to access asset 58, RFID reader 56 reads license information contained on RFID tag 60. After the license information contained on RFID tag 60 is read successfully, this license information must be verified. If the information contained on RFID tag 60 is successfully verified, media player 50 is allowed access to asset 58. In the exemplary embodiment of FIG. 3, when access to asset 58 is granted, media player 50 is able to output asset 58 onto output component 54. However, if the information contained on RFID tag 60 is not successfully verified, media player 50 is not allowed access to asset 58. As described above, this ensures that access by a media player to a license protected asset, such as digital movies or music, is in accordance with the terms of the asset's license.

This invention ensures, through RFID technology, that access to license protected material only occurs when that access complies with the terms of the license agreement or copyright law applicable to that material. The present invention can be applied to any device that accesses license or copyright protected material. For example, even though the above examples relate to devices that access digital material, this invention may also be applied to devices, such as photocopy machines, that access non-digital material. In addition, this invention can ensure compliance with any term of a license that a licensor desires.

Although the present invention has been described with reference to preferred embodiments, workers skilled in the art will recognize that changes may be made in form and detail without departing from the spirit and scope of the invention.

1. A system for limiting access to a license protected asset, the system comprising:
at least one radio frequency identification (RFID) tag storing license information associated with the asset;
a device capable of using the at least one asset, the device including at least one RFID reader operable with the device;
wherein access by the device to asset is allowed only if the license information stored on the at least one RFID tag is successfully read and verified.

2. The system of claim 1, wherein the license information is required to be read and verified by the RFID reader to allow access by the device to the asset each time the device attempts to access the asset.

3. The system of claim 1, wherein the license information is required to be read and verified by the RFID reader to allow access by the device to the asset only an initial time that the device attempts to access the asset.

4. The system of claim 1, wherein the license information stored on the RFID tag is destroyed after the asset is accessed by the device.

5. The system of claim 1, wherein the license information comprises a counter that tracks a number of times the asset has been accessed, so that access can be prevented after the asset has been accessed a threshold number of times.

6. The system of claim 1, wherein the license information comprises date or time information so that access to the asset can be prevented after an expiration date or amount of time.

7. The system of claim 1, wherein the license information comprises information about hardware of the device that has accessed the asset.

8. The system of claim 7, wherein access to the asset is limited to hardware of a single device.

9. The system of claim 1, wherein a notification is automatically provided when the license information indicates that access to the asset is no longer allowed.

10. The system of claim 1, wherein the at least one RFID tag is embedded or attached to either the physical storage medium of the asset or a case that carries the physical storage medium of the asset.

11. A method of limiting access to a license protected asset, the method comprising:
storing license information associated with the asset in at least one radio frequency identification (RFID) tag;
allowing access to the asset by a device only upon successful retrieval and verification of the license information by a device having at least one RFID reader.

12. The method of claim 11, wherein the license information is required to be retrieved and verified to allow access to the asset each time access is attempted.

13. The method of claim 11, wherein the license information is required to be retrieved and verified to allow access to the asset only an initial time that access to the asset is attempted.

14. The method of claim 11, wherein the license information stored on the RFID tag is destroyed after the asset is accessed.

15. The method of claim 11, wherein the license information comprises a counter that tracks the number of times the asset has been accessed, so that access can be prevented after the asset has been accessed a threshold number of times.

16. The method of claim 11, wherein the license information comprises date or time information so that access to the asset can be prevented after an expiration date or amount of time.

17. The method of claim 11, wherein the license information comprises information about hardware that has accessed the asset.

18. The method of claim 17, wherein access of the asset is limited to hardware of a single device.

19. The method of claim 11, wherein a notification is automatically provided when the license information indicates that access to the asset is no longer allowed.

20. The method of claim 11, wherein the license information comprises concurrent user information so that access to the asset can be limited to a threshold number of concurrent users.
